(19) United States
(12) Patent Application Publication
(10) Pub. No.: US 2012/0058448 A1
(43) Pub. Date: Mar. 8, 2012

(54) PROSTHESIS MOUNTING DEVICE AND CARRIER TOOL FOR USE IN MINI IMPLANT FIXED/REMOVABLE PROSTHODONTIC APPLICATIONS

(76) Inventor: Moe Keng Ang, Kuala Lumpur (MY)

(21) Appl. No.: 13/320,078

(22) PCT Filed: Nov. 11, 2010
(86) PCT No.: PCT/MY2010/000257

§ 371 Date: Nov. 11, 2011

(30) Foreign Application Priority Data
Jan. 11, 2010 (MY) MYPI201000113

(51) Int. Cl. A61C 8/00

(52) U.S. Cl. 433/159; 433/173

(57) ABSTRACT

A prosthesis mounting device (30) for mounting onto mini dental implants (50), of generally frusto-conical shape with an axial recess (20), which base (21) has overhang (33) over the collar (34) of a mini implant (50). Together with a two stage cement removal process this provides a prosthodontic solution to the problem of excess cement removal in mini implant fixed restorations. When an annular groove is provided at location (6) and anti rotation means (not shown) is provided on the external wall (19) the prosthesis mounting device (30) can function as a denture attachment device. A carrier tool (80) to enable easy handling in the mouth is also provided.

### BACKGROUND OF THE INVENTION

1. Technical Field of the Invention

This invention relates to dental implant supported prostheses in general and, in particular, to a device with carrier tool to deliver a prosthodontic solution in the use of mini dental implants for fixed/removable prosthodontic applications.

2. Description of the Prior Art

Imtec Corporation, now a 3M Company, has largely been instrumental in pushing forward the concept of minimally invasive implant dentistry to the benefit of dentist and patient alike. The O-ball head mini dental implant is simple to install, versatile, applicable in removable and fixed prosthodontic applications. U.S. Pat. No. 6,716,030 granted to Sendax et al has much teaching on this.

However, a prosthodontic solution for the use of O-ball head mini dental implants in fixed prosthodontic solutions is still wanting. U.S. Pat. No. 7,108,511 granted to Shatkins teaches Dr Shatkins' F.I.R.S.T technique. In this technique, mini dental implants are used to support fixed crowns and bridges with the use of dental cement. Excess dental cement with its possible negative local and systemic effects is not addressed. Most dentists would try their best to remove as much excess (tedious process) and hope for the best.

Imtec Corporation has coined the term ‘ponabut’ to name a fixed restoration supported by mini implant. Such a restoration is a ‘pontic’ in that the prosthesis does sit on gum tissue as in conventional crown and bridge dentistry. Yet there is the presence of the mini implant abutment protruding beyond the gum sited within this ‘pontic’. ‘Pontic-abutment’ or ‘ponabut’ is apt. Imtec Corporation has thoughtfully addressed the problem of excess cement by the use of light cure composite to carefully fill up any irregularities under a ‘ponabut’ followed by carefully polishing before cementation. There will be less cement excess but, nevertheless, it is there, not visible and not removable, in spite dentist's best effort.

Now, mini dental implants in use are usually small titanium screws of diameter less than 3 mm, The threaded portion of this screw is intended for intrabony insertion. An intragingivally placed collar follows, which has considerable variation in design. Some are cylindrical, some are flared, of various sizes. But, generally, the abutment end that protrudes beyond the gum comprises a multifaceted nut which is engaged by a tool to enable threaded advancement into bone. The common O-ring receiver abutment design comprises a generally spherical O-ball head with neck which sits on the aforementioned nut. Or the nut may be extended to form a ‘nut-head’ abutment. Various designs around this general construct are available.

The common characteristic would be the abutment end having a multifaceted nut and extension with O-ball head or other head design, usually slim and irregular in profile. This is good for ease of insertion in the confines of the mouth, but not good for doing fixed restorations. The slim and irregular profile means direct impression results in breakage in a cast model and indirect impression techniques, more tedious and costly, should be employed. Besides, fixed restorative techniques result in a ‘ponabut’ situation and current techniques cannot eliminate the excess cement problem. It also feels uncomfortable in a patient's mouth. It would be advantageous to have the size and shape of the mini implant abutment augmented and modified to enable direct impression taking, which would reduce time and expense, and enhance patient comfort.

Temporization usually involves use of temporary cement which is messy and requires some force to remove. A snap fit temporization means would be more convenient. And, if preferred, a snap fitted ‘permanent’ restoration which is entirely snappable on and off is possible. In such instance, there will be no excess cement at all.

There exists in the field a need for a solution to the problem of excess cement with mini implant a supported prosthodontic restoration (‘ponabuts’). This would advance the successful use of mini dental implants for fixed prosthodontic restorations. And being able to use a direct impression technique is advantageous. And having snap-fit temporarization means would be more convenient. And having a snap-fit ‘permanent’ restoration would do away with excess cement altogether.

O-ball head mini implants are also used to stabilize dentures via connection to ‘O-ring in housing’ denture attachments. The process requires a block out shim step so that cold cure acrylic would not lock in the denture attachments.

There exists in the field a need for a simpler procedure for removable denture attachment.

### SUMMARY OF THE INVENTION

The present invention discloses a prosthesis mounting device and its carrier tool which, when applied to a mini dental implant, solves the excess cement problem in mini implant supported fixed restorations.

Another object is to make the job of restoring function and esthetics using mini dental implants easier and cheaper by enabling a direct impression technique through modification of the slim and irregular profile of a mini dental implant. This would also increase patient comfort in the mouth.

A further object of this invention is to provide snap fit temporarization means where possible, such as when the O-ring abutment type mini implant is used. And in this instance, a ‘permanent’ restoration may be entirely snappable on and off, obviating the need for cement fixation.

Yet a further object is to enable the aforementioned snap fit temporarization means to function as a denture attachment device which does not need a bock out shim step.

The foregoing objects are met in this disclosure of a prosthesis mounting device and its carrier tool. This device is made of metal such as surgical steel, preferably titanium or its alloy and would be generally frusto-conical shaped in external profile with a basal opening from which an axial recess resides. Of course, certain polymeric materials and their composites may also be used. This axial recess is preferably substantially cylindrical in shape and sized to fit over the abutment of a mini dental implant, with adequate space for dental cement. Various tapers and flats may be engineered to ensure fit with the mini implant abutment. The base of the device shall rest on the platform of the intragingivally placed collar. And, the diameter of this base shall extend for a short distance circumferencially around the platform of the intragingivally placed collar of a mini dental implant. This distance could range from 0.5 mm to 2 mm, forming a base diameter of 3.8-4.2 mm, preferably 3.85 mm.

In use, a mini dental implant is placed into the jawbone with the intragingival collar flushed with the gum and the abutment comprising nut and head protruding from the gum. The inventive device is placed over the abutment and onto the platform that defines the upper surface of the intragingivally placed collar and cemented on. Excess cement around implant is readily removed as the margin for clearance is small and easily assessed by a dental probe/dental floss. Once excess cement has been removed, a direct impression is taken and cast model sent to the lab. When the final prosthesis (dental prostheses may comprise crowns, bridges or dentures) is ready, cement is applied. Excess cement will flow out to regions of least resistance rather than towards the implant. Again, excess cement is readily removed. Thus a small circumferential overhang around the intragingivally placed collar and a two stage removal process for excess cement removal accomplishes the heretofore unsolvable excess cement removal task.

Now it is known in the art to use O-rings to grip onto the neck of O-ring abutments. An annular groove may be set into the recess of this inventive device to seat an O-ring for this purpose. This O-ring may be correctly sized to fit the dimensions of the O-ring abutment. Many sizes and materials are available. The preferred O-ring may be a commonly available orthodontic ligature size 120. With this feature, when mini implants with O-ring abutments are used, temporarization need not be achieved with messy temporary cement. Just snap on and snap off And, if so desired, a ‘permanent’ restoration can be ‘fixed’ removably with this means in the case where an O-ring abutment type mini implant is used. And, if the material used was plastic, the ‘O-ring’ could be integrally formed at the desired location.

The aforementioned removable prosthesis attachment device can be furnished with antirotation means on its external contour, such as flats, non-annular grooves, knurls and the like. With this feature, the device is perfectly suited to function as a denture attachment means with O-ball head mini implants, without the need for block out shims.

This prosthesis mounting device is a little device, with base around 4 mm and height of 4-8 mm, preferably 5 mm. It is difficult to manually manipulate this little device in the mouth indeed. So herein is disclosed a simple tool to aid in carrying the inventive device to the desired location.

This carrier tool is a modified curved artery/fragment forceps. Such locking forceps with the gripping tip fashioned to conform to the profile of the prosthesis mounting device of this invention can effectively grip, hold and release the prosthesis attachment device in the confines of the mouth. The curvature of the forceps may be from 45 degrees to 90 degrees, preferably about 65 degrees. (The complementary curvature would be 135 degrees to 90 degrees.)

The following description will describe the invention in clearer detail and various features and advantages will be further highlighted.

### BRIEF DESCRIPTION OF THE DRAWINGS

FIG. 1 is a front view of the prosthesis mounting device of this invention engaging an O-ring abutment type mini dental implant disposed in a jawbone

FIG. 2 is an end view of the prosthesis mounting device of this invention

FIG. 3 is a perspective view of the carrier tool of this invention

FIG. 4 is a magnified view of the gripping tip

### DETAILED DESCRIPTION OF THE DRAWINGS

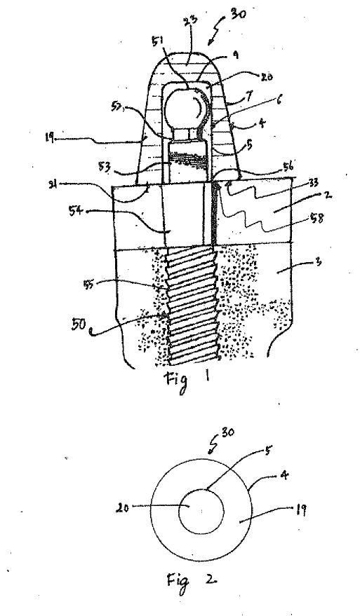

FIG. 1 shows the prosthesis mounting device (30) of this invention engaging an O-ring abutment type (O-ball head) mini dental implant (50) disposed in a jawbone (3). The O-ball head mini implant (50) has threaded portion (55) disposed in bone (3) and collar (54) disposed in gum (2). Above the gum (2) level, would be the nut (53) sitting on the platform (56) of the collar (54). And the O-ball head (51) and neck (52) is just above the nut (53). The nut (53) with the O-ball head (51) and neck (52) constitutes the abutment of mini implant (50).

Referring to FIG. 1, the prosthesis mounting device (30) of this invention has a generally frusto-conical shaped housing (7) with a broader circular base (21) tapering convergently to an apical end. The frusto-conical shaped housing (7) has a peripheral wall (19) encompassing a recess (20). This recess (20) extends axially from the circular base (21) and ends at a roof (9) formed by the capping (23) at the apical end of the prosthesis mounting device (30). This recess (20) is substantially cylindrical in shape but may be tapered or provided with flats (not shown) and sized to engage the abutment of a mini implant (50). There should be sufficient space in the recess (20) to accommodate dental cement. The inner wall (5) of the peripheral wall (19) may, at location (6), be provided with an annular groove (not shown) to seat an O-ring (not shown). An O-ring at this location would grip the neck of an O-ring abutment type mini dental implant (55). This feature will enable snap on/snap off ‘fixation’ of a ‘permanent’ restoration and no cement need be used.

With this aforementioned construct, an anti-rotation means such as knurls, flats, non annular grooves or notches (not shown) on the external wall (19) will enable the prosthesis mounting device (30) to function as a denture attachment device, without needing a block out shim step.

Focusing now on the circular base (21), note the circumferential overhang (33) resting beyond the platform (56) of collar (54). Now when cement is applied into recess (20), excess will ooze out between the space between the base (21) and gum (2) around the region of the circumferential overhang (33). This circumferential overhang (33) is small, about 0.5 mm to 2 mm. Excess cement around the implant-gum junction (58) is readily removed with dental probe/scaler/floss. Now, consider a prosthesis mounting device (not shown) that rests flush with the edge of the collar, or is set inwards of the edge of the collar. If there is no overhang (33) as in this invention, then, during cementation of the crown, seepage of cement into the implant-crown junction will occur. An overhang (33) covers this implant-crown junction (58) and protects this implant-gum junction (58) from access to cement during crown cementation. And excess cement is readily removed, resting assured that the first cement removal process when the prosthesis mounting device (30) was first cemented to the implant (50) had removed that excess cement at the implant-gum junction (58).

Thus the use of the prosthesis mounting device (30) of this invention with overhang (33) beyond the collar (54) and a two stage cement removal process solves the excess cement removal problem with fixed restorations on mini implants.

The next object of this invention is to enable direct impression taking. The shape of the prosthesis mounting device (30) is generally frusto-conical. The external wall (4) of the peripheral wall (19) is smooth and has no undercuts, the edges are preferably rounded. The diameter of the base (21) of around 4 mm and height of around 5 mm with frusto-conical shaping would offer option of direct impression taking, compared to the around 2.5 mm diameter sizing of a usual mini implant abutment. Of course, small grooves and markings, angulations and facets may still be included.

FIG. 2 shows the end view of the prosthesis mounting device (30).

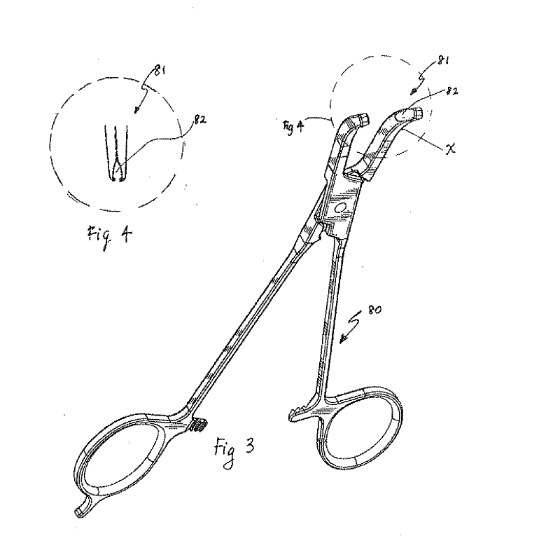

FIG. 3 shows a perspective view of the carrier tool (80) for the prosthesis mounting device (30) of this invention. This is a curved locking forceps such as an artery/fragment forceps with similar construct. The gripping tip (81) is fashioned to conform to the size and contours of the prosthesis mounting device (30) as shown in the magnified view in FIG. 4 at (82). The curvature of the gripping tip (x) may be 45 degrees to 90 degrees, preferably 65 degrees. At this angulation, a prosthesis mounting device (30) is securely and conveniently carried to the desired location in the mouth and, on releasing, easily deposited on the mini implant (50). Without this carrier tool (80), manipulating a tiny device like this prosthesis mounting device (17) inside the confines of the oral cavity would be that much harder.

The disclosure of the prosthesis mounting device (30) and the carrier tool (80) should advance the successful use of the mini dental implant, especially in fixed prosthodontic restorations. The teachings of this invention is not limited to one particular embodiment, many adaptations according to the principles set out are possible. Such variations are not to be regarded as a departure from the principles and scope of the invention, and all such modifications as would be obvious to one skilled in the art are intended to be included in the scope of the following claims.

1. A prosthesis mounting device (30) that can be mounted on a mini dental implant (50) for the purpose of mounting a dental prosthesis wherein the prosthesis mounting device (30) comprises
a housing (7), the housing (7) comprising a peripheral wall (19) having a capping (23) at one end and a circular base (21) with an opening at the other end, with the continuous peripheral wall (19) defining an axial recess (20) having a roof (9) at the capping (23) and an opening at the circular base (21); and said circular base (21) is intended to rest on the platform (56) of the collar (54) of a mini dental implant (50) with said circular base (21) extending a small distance circumferentially beyond the collar (54) in the form of overhang (33) when the axial recess (20) is mounted on a mini dental implant (50).

2. A dental prosthesis mounting device (30) that can be mounted onto a mini dental implant (50) as in claim 1 wherein the housing (7) is generally frusto-conical shaped.

3. A dental prosthesis mounting device (30) that can be mounted onto a mini dental implant (50) as in claim 1 wherein the external wall (5) of the peripheral wall (19) is generally smooth and rounded to facilitate direct impression taking.

4. A prosthesis mounting device (30) that can be mounted onto a mini dental implant (50) as in claim 1 wherein the axial recess (20) is substantially cylindrical.

5. A prosthesis mounting device (30) that can be mounted onto a mini dental implant (50) as in claim 1 that can be cemented onto said mini implant (50).

6. A prosthesis mounting device (30) that can be mounted onto a mini dental implant (50) as in claim 1 wherein axial recess (20) is provided with an annular groove at a location (6) to enable seating of an O-ring there to engage the neck (52) of an O-ball head mini implant (50) whence the prosthesis mounting device (30) can be snap fitted onto said mini implant (50).

7. A prosthesis mounting device (30) that can be mounted onto a mini dental implant (50) as in claim 6 wherein the external wall (19) is provided with anti-rotation means such as knurls, flats, non-annular grooves or notches (not shown) whence the prosthesis mounting device (30) can function as a denture attachment device.

8. A prosthesis mounting device (30) that can be mounted onto a mini dental implant (50) as in claim 1 wherein the material used is metal.

9. A prosthesis mounting device (30) that can be mounted onto a mini dental implant (50) as in claim 1 wherein the material used is titanium.

10. A prosthesis mounting device (30) that can be mounted onto a mini dental implant (50) as in claim 1 wherein the material used is polymeric material.

11. A carrier tool (80) that can be used to securely grip, hold and release a prosthesis mounting device (30) comprising a curved locking forceps with gripping tip (81) configured to conform to the size and contours of a prosthesis mounting device (30) as depicted in (82).

12. The use of the prosthesis mounting device (30) of claim 1 to solve the problem of excess cement clearance in mini implant fixed restorations.

13. The use of the prosthesis mounting device (30) of claim 1 to enable direct impression taking.

14. The use of the prosthesis mounting device (30) as in claim 6 for use in temporarization.

15. The use of the prosthesis mounting device (30) as in claim 7 for use in denture attachment.
